(19) United States
(12) Patent Application Publication
(10) Pub. No.: US 2018/0290856 A1
(43) Pub. Date: Oct. 11, 2018

(54) Pipe Unroller

(71) Applicants: Steve Buller, Hazelton, ID (US); Craig Buller, Murtaugh, ID (US)

(72) Inventors: Steve Buller, Hazelton, ID (US); Craig Buller, Murtaugh, ID (US)

(21) Appl. No.: 15/482,719

(22) Filed: Apr. 8, 2017

(51) Int. Cl. B65H 49/28; B65H 49/32; B62B 1/26; B62B 1/10

(52) U.S. Cl. CPC B65H 49/28; B65H 49/32; B62B 2202/025; B62B 1/10; B62B 1/264

(57) ABSTRACT

To provide an open coil pipe unroller for use especially with plastic piping or tubing uncoiling. The apparatus includes a frame with wheels, handle, a bearing system centrally disposed, and a turntable mounted with said bearing system to ensure accurate, even rotating of turntable to efficiently and effectively unroll piping without kinking, and an apparatus centrally mounted over the turntable used for holding and aiding in the unrolling of spooled wire while unrolling pipe, all done by a single worker, thereby saving much time and financial loss from paying a worker wages to do what this device is designed to do by itself.

### BACKGROUND OF THE INVENTION

The invention relates to a pipe coil unroller.

Plastic piping being pulled through into the ground or pulled out otherwise over the ground poses the problem of the open coil expanding and becoming very difficult to handle and also not uncoiling in a smooth fashion if uncoiled above ground. This apparatus not only unrolls open coil pipe smoothly above or under ground, but also eliminates the prior method of a worker holding to the unwieldy open coil of pipe to help it uncoil.

Beyond the use of uncoiling pipe, this apparatus also includes a removable device for the use of unrolling spooled wire at the same time as the pipe. The whole apparatus remains in a fixed position while the object pulls the pipe and/or wire off of the unroller.

### SUMMARY OF THE DRAWINGS

FIG. 1 shows a detailed exploded view of the pipe unroller in a resting position with the turntable 36 raised above the frame 1 and the wire spool unroller 37a also raised above the turntable and the wire guide 37b turned outward for better clarity of the drawing. It also shows with one wheel 9 missing also for better clarity of the drawing.

### SUMMARY OF THE INVENTION

The summary of the invention is to provide a new system for uncoiling open coil pipe material.

One object of this invention is to provide an apparatus that replaces the use of a person uncoiling pipe, thereby making uncoiling a single man job.

Another object of the invention is to provide a handle that extends upward from the front of the frame to permit access of hands while the unroller is in full contact with the surface of the ground.

Yet another object of the invention is to provide a pipe unroller with a frame having a bearing system centrally located on the frame upon which a turntable is mounted to provide accurate, smooth rotating of the turntable.

Still another object of the invention is to provide a frame with vertically disposed bars to retain the pipe in a roll as it unrolls.

Yet another object of the invention is to provide a turntable upon which is fastened sheet material to keep pipe material from getting tangled in the turntable frame and the main frame.

Another object of the invention is to provide a turntable with vertically disposed arms to keep pipe retained inside the turntable and with horizontal bars attached at the vertex of the vertical bars that are movable, allowing placement of pipe onto the turntable and when returned to the original position maintain the pipe on the turntable.

The final object of the invention is a wire spool unroller that can be used at the same time as the pipe unroller and is removably centrally mounted above the turntable to allow the unrolling of wire in addition to pipe.

### DETAILED DESCRIPTION

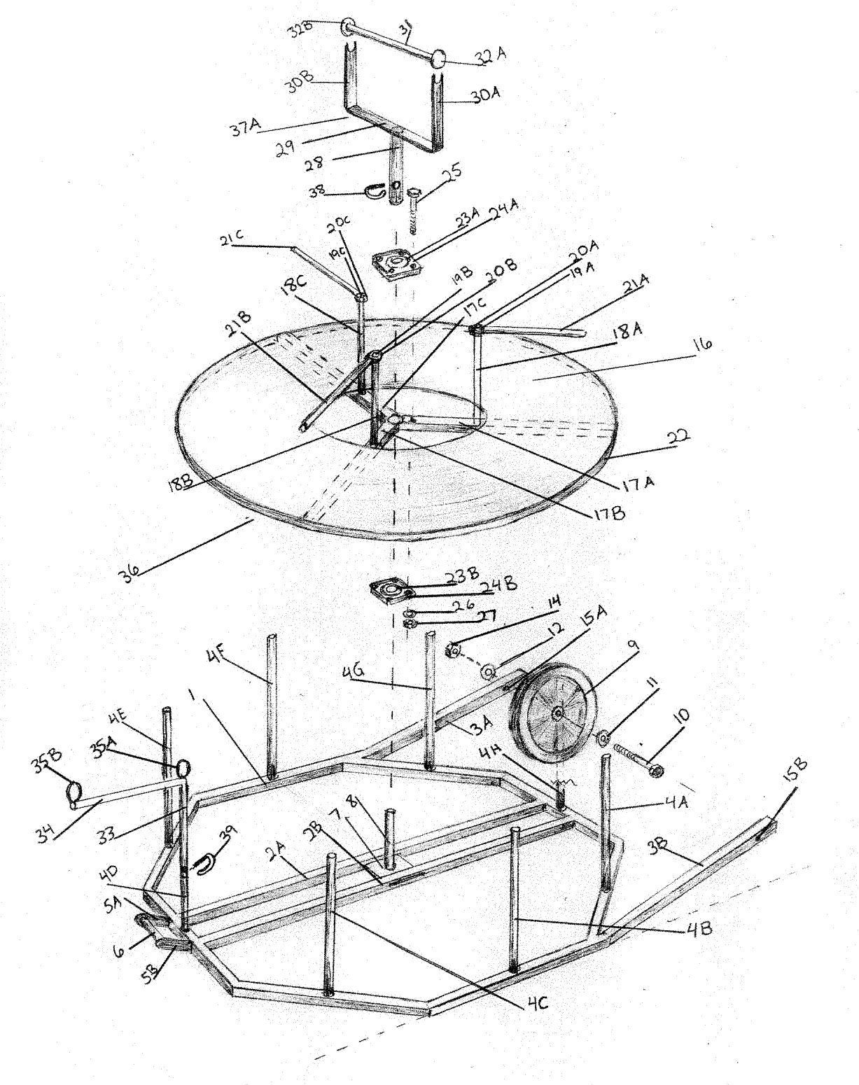

In FIG. 1, there is a view of the pipe unroller in an exploded horizontal position with a frame 1 and turntable 36 and also a wire unrolling device 37a and 37b. The turntable 36 is mounted to the frame 1 with a set of 2, four bolt flange bearings, 23A and 23B and 24A and 24B, fastened together from opposite ends to ensure even rotating of the turntable 36 in relation to the frame 1 with four bolts 25A-25D, four washers 26A-26D and four lock nuts 27A-27D. The turntable frame, 17A, 17B, and 17C are connected together at a central point and having the outside ends capped off with a flat annular ring 22. Mounted on the turntable frame are three vertically disposed rods 18A-18C with a threaded rod 19A-19C attached at the vertex to enable the horizontally disposed swinging bars 21A-21C to tighten down to a secure placement in relation to the exterior of the turntable made possible by a threaded nut 20A-20C attached to the end of the same said horizontally swinging bars 21A-21C. Also mounted on the turntable frame 17 is a rigid sheeting material 16 to ensure material that is unrolled off of the turntable 36 is kept from being tangled in the frame 17.

The exterior frame 1 continues to the rearward and bends upward to form the legs 3A and 3B through which are drilled a hole 15A and 15B. The wheel 9A and 9B is then mounted to the legs 15 by a bolt 10A and 10B, washers 11A and 11B and 12A and 12B, and locknut 14A and 14B. The handle 6 is held to the frame by the two side pieces 5A and 5B on the front of the frame 1 as opposed to the wheels 9. In the centermost point of each of the octagonal frame pieces are mounted upright rods 4A-4H around the perimeter of the frame 1. Extending from the front to the rear of the frame 1 in the center are two bars 2A and 2B that are mounted to the frame for rigidity and for support for the plate 7 that in turn holds the tubular bar 8 through which the turntable 36 and bearing system 23 and 24 are mounted.

The wire unspooler 37A comprises of a hollow bar 28 that is placed over the center bar for the bearing 8 onto which is attached a c-channel 29 with two upright pieces 30A and 30B attached, one on either side of said c-channel 29 and extending upwards with a round groove cut out of the top of each one onto which the rod 31 is placed when it is threaded through a wire spool. The rod 31 also has a small round plate 32A and 32B on each end of it to ensure that the rod 31 will not roll off of the upright bars 30A and 30B when in operation.

Number 37B is the wire guide for the wire unspooler 37A to ensure the wire to safely travel over the turning pipe when unrolling wire and pipe at the same time. It consists of a upright hollow bar 33 that fits over the upright bar 4C and is attached with a locking pin through both bars to keep it secure. Bar 34 is attached to bar 33 and is mounted at a right angle to bar 33. Then to the top of bar 34 is attached metal o-rings 35A and 35B through which the wire is strung to keep it out of the way of the turning turntable bars and pipe. The wire guide 37B is turned inward over the turntable 36 when in operation in opposition to the drawing which shows it turned outward for better clarity of drawing.

A pipe unroller comprising:

What is claimed is:

1. A frame having an octagonoal or other shape through which the center thereof run frame members to which is held in the middle most point a vertical bar extending upward, and having vertically disposed bars on the upper portion of the horizontal exterior frame members, a frame having wheels that extend upward and outward from the frame;
a frame having a handle extending upward and outward from the frame;
a turntable having a frame with bars radiating horizontally outward from the center thereof in a spoked fashion with a bearing system centrally located;
a wire unspooler removably secured to the center vertical bar;
a wire guide removably secured to the exterior vertically disposed bars.

2. The apparatus of claim 1, wherein said vertically disposed upright pieces are secured to the upper portion of the horizontal exterior frame members for the retention of pipe on the turntable.

3. The apparatus of claim 2, wherein said vertical bars provide hold for a removably attached wire guide.

4. The apparatus of claim 1, wherein the frame extends to the rearward, as opposed to the handle, and past the main frame and ascends so that the wheels disengage from the ground when in a fully horizontal position.

5. The apparatus of claim 1, wherein said handle on the front of the frame, as opposed to the wheels, extends upward and outward to permit the access of hands when the frame is fully lowered to the ground.

6. The apparatus of claim 1 wherein said frame comes in full contact with the ground when fully lowered, by reason of the wheels and handle extending upward off the ground to provide ultimate friction of the frame with the surface of the ground while in operation.

7. The apparatus of claim 1, wherein the turntable frame having vertical bars extending upward from the frame in a spaced location in relation to the central pivot point.

8. The apparatus of claim 7, wherein the vertical bars have horizontally movable bars, at the vertex thereof, that extend to the outside of the turntable radius and retract into the center thereof also.

9. The apparatus of claim 1, wherein the turntable has sheeting material attached on the upper portion of the turntable frame from the inner upright vertical bars, whereon the horizontally movable bars are attached, radially outward to the extent of the turntable frame.

10. The apparatus of claim 1, wherein said central frame members having the plurality of frame members connecting together in a central location to provide means to attach a vertically disposed bar facing upward.

11. The apparatus of claim 10, wherein said vertically disposed upward facing bar provides a means to attach to the bearing system of the turntable.

12. The apparatus of claim 10, wherein said vertically disposed facing bar provides hold for a removably secured wire unspooler to be attached.

13. The apparatus of claim 1, wherein said wire unspooler is secured to the central vertically disposed bar and has a horizontal bar extending above and across the center thereof and extending in an equally spaced location in relation to the vertical bar.

14. The apparatus of claim 13, wherein said horizontal bar has vertically disposed upright pieces at the ends of the same said horizontal bar and provide hold at the vertex for a removable rod to be placed whereon a wire spool is threaded around said removable rod.

15. The apparatus of claim 1, wherein said wire guide has a horizontal bar facing the center of the frame attached at the vertex of the vertical bar whereon are attached, one on either end, but not limited to, rings for wire retention.

16. A pipe unroller comprising:
a frame having octagonal shape through which the center thereof run a plurality of bars, and having vertically disposed bars attached to the upper section of the exterior frame members;
a turntable having a frame with bars extending horizontally outward from the center thereof in a spoked fashion.

17. The apparatus of claim 16, wherein said central through bars attach to the interior of exterior frame to provide rigidity for the frame and whereupon is also attached a bar to which a rod is vertically disposed fastened.

18. The apparatus of claim 10, wherein said vertically disposed bars extend downward and through, but not beyond the exterior horizontal frame pieces and upward to a set point, there being no fewer than, but not limited to 8, in number.

19. The apparatus of claim 16, wherein a turntable with not more than 3, but not limited in number to, bars extending horizontally outward from the center thereof in a spoked fashion acting as a turntable frame.

20. The apparatus of claim 19, wherein said turntable frame bars each having a vertically disposed bar that extends downward and through, but not beyond, said turntable horizontal frame bars, and extends upward to the vertex, being fastened to the turntable frame in an equally spaced location in relation to the pivot point.
